(19) United States
(12) Patent Application Publication
(10) Pub. No.: US 2010/0098179 A1
(43) Pub. Date: Apr. 22, 2010

(54) METHOD AND APPARATUS FOR TRANSMITTING AND RECEIVING ORTHOGONAL FREQUENCY DIVISION MULTIPLEX-BASED TRANSMISSIONS

(75) Inventors: Erdem Bala, Farmingdale, NY (US); Sung-Hyuk Shin, Northvale, NJ (US); Guodong Zhang, Syosset, NY (US); Joseph S. Levy, Merrick, NY (US); Philip J. Pietraski, Huntington Station, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL PATENT HOLDINGS, INC., Wilmington, DE (US)

(21) Appl. No.: 12/579,806

(22) Filed: Oct. 15, 2009

Related U.S. Application Data
(60) Provisional application No. 61/105,984, filed on Oct. 16, 2008.

(51) Int. Cl. H04L 27/28

(52) U.S. Cl. 375/260

(57) ABSTRACT

A method and apparatus for transmitting and receiving orthogonal frequency division multiplex (OFDM)-based transmissions are disclosed. Control information may be transmitted at least one symbol prior to the corresponding data symbols so that a wireless transmit/receive unit (WTRU) has time to determine which parts of the subcarriers need to be received without having to buffer any corresponding data symbols. Control information related to frequency location of the data may be received in the first subframe and control information not related to the frequency location of the data may be received in the second subframe that includes the corresponding data. The offset between the control information and the data may be a fixed value, may be received from the network, or may be included in the control information preceding the corresponding data.

### CROSS REFERENCE TO RELATED APPLICATIONS

This application claims the benefit of U.S. provisional application No. 61/105,984 filed Oct. 16, 2008, which is incorporated by reference as if fully set forth.

### FIELD OF INVENTION

This application is related to wireless communications.

### BACKGROUND

The Third Generation Partnership Project (3GPP) has initiated the Long Term Evolution (LTE) initiative to bring new technology, new network architecture, new configurations, and new applications and services to wireless networks in order to provide improved spectral efficiency and faster user experiences. In order to further improve achievable throughput and coverage of LTE-based radio access systems and meet the IMT-Advanced requirements of 1 Gbps and 500 Mbps in the downlink and uplink directions, respectively, LTE-Advanced (LTE-A) is currently under study in the 3GPP standardization body.

LTE has chosen orthogonal frequency division multiple access (OFDMA) for the downlink. An orthogonal frequency division multiplex (OFDM) signal comprises a set of resource elements (RE) defined by specific OFDM symbols and subcarriers.

In LTE, a subframe is partitioned into two parts: a control field and a data field. The control field spans the entire system bandwidth and is transmitted via the first N OFDM symbols of the subframe. FIG. 1 shows transmission of the downlink control information and data in a subframe. In each subframe, control symbols (e.g., C1 symbols), are followed by the corresponding data symbols (e.g., D1 symbols) included in the same subframe. A wireless transmit/receive unit (WTRU) listens to the control field to get downlink grants that inform the WTRU which subcarriers will carry the data for the WTRU.

Having the data follow immediately after the control information puts a processing burden on the WTRU. Since the WTRU does not know frequency location to receive its downlink data until decoding the control information, the WTRU needs to buffer the data from the entire bandwidth until the downlink control information is decoded. In cases where the WTRU receives data infrequently, a large fraction of power may be consumed to buffer a large amount of OFDM symbols that are likely to be dropped anyway because they are not destined for the WTRU. The problem is greatly amplified in LTE-A systems where the cell bandwidth may be aggregated up to 100 MHz that may not necessarily be contiguous.

### SUMMARY

A method and apparatus for transmitting and receiving OFDM-based transmissions are disclosed. Control information may be transmitted at least one symbol prior to the corresponding data symbols so that a WTRU has time to determine which parts of the subcarriers need to be received without having to buffer any corresponding data symbols. Control information related to frequency location of the data may be received in the first subframe and control information not related to the frequency location of the data may be received in the second subframe that includes the corresponding data. The offset between the control information and the data may be a fixed value, may be received from the network, or may be included in the control information preceding the corresponding data.

### BRIEF DESCRIPTION OF THE DRAWINGS

A more detailed understanding may be had from the following description, given by way of example in conjunction with the accompanying drawings wherein:

FIG. 1 shows transmission of the downlink control information and data in each subframe;

FIG. 2 shows an example LTE wireless communication system/access network that includes an Evolved-Universal Terrestrial Radio Access Network (E-UTRAN);

FIG. 3 is a block diagram of an example LTE wireless communication system including a WTRU, an evolved Node-B (eNB), and a mobility management entity/serving gateway (MME/S-GW);

FIG. 4 shows an example transmission of downlink control information and data in accordance with one embodiment;

FIG. 5 shows an example transmission of downlink control information and data in accordance with another embodiment; and

FIG. 6 shows an example transmission of downlink control information and data in accordance with yet another embodiment.

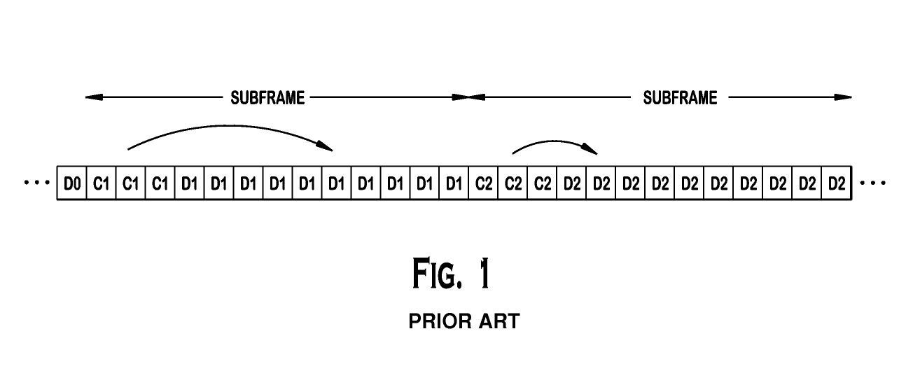

### DETAILED DESCRIPTION

When referred to hereafter, the terminology “WTRU” includes but is not limited to a user equipment (UE), a mobile station, a fixed or mobile subscriber unit, a pager, a cellular telephone, a personal digital assistant (PDA), a computer, a relay used in a network, or any other type of device capable of operating in a wireless environment. When referred to hereafter, the terminology “Node-B” or “eNB” includes but is not limited to a base station, a site controller, an access point (AP), or any other type of interfacing device capable of operating in a wireless environment.

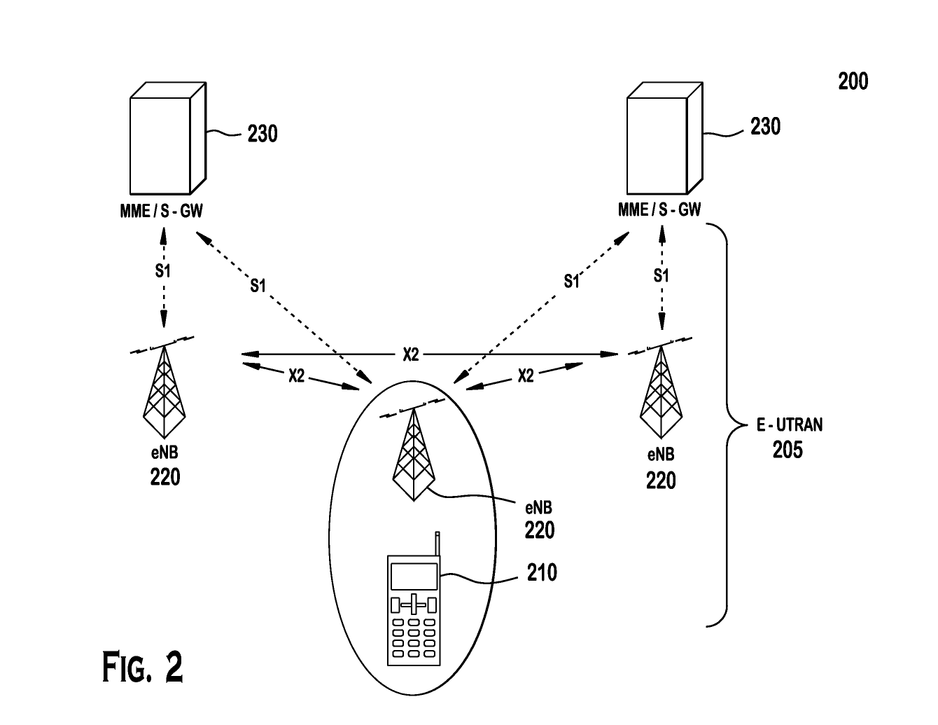

FIG. 2 shows an LTE wireless communication system/access network 200 that includes an E-UTRAN 205. The E-UTRAN 205 includes a WTRU 210 and several evolved Node-Bs 220. The WTRU 210 is in communication with an eNB 220. The eNBs 220 interface with each other using an X2 interface. Each of the eNBs 220 interface with an MME/S-GW 230 through an S1 interface. Although a single WTRU 210 and three eNBs 220 are shown in FIG. 2, it should be apparent that any combination of wireless and wired devices may be included in the wireless communication system access network 200.

FIG. 3 is a block diagram of an example LTE wireless communication system 300 including the WTRU 210, the eNB 220, and the MME/S-GW 230. As shown in FIG. 3, the WTRU 210, the eNB 220 and the MME/S-GW 230 are configured to perform a method of transmitting and receiving OFDM-based transmissions.

In addition to the components that may be found in a typical WTRU, the WTRU 210 includes a processor 316 with an optional linked memory 322, at least one transceiver 314, an optional battery 320, and an antenna 318. The processor 316 is configured to perform, either alone or in association with software, a method of receiving OFDM-based transmissions. The transceiver 314 is in communication with the processor 316 and the antenna 318 to facilitate the transmission and reception of wireless communications. In case a battery 320 is used in the WTRU 210, it powers the transceiver 314 and the processor 316.

In addition to the components that may be found in a typical eNB, the eNB 220 includes a processor 317 with an optional linked memory 315, transceivers 319, and antennas 321. The processor 317 is configured to perform, either alone or in association with software, a method of transmitting OFDM-based transmissions. The transceivers 319 are in communication with the processor 317 and antennas 321 to facilitate the transmission and reception of wireless communications. The eNB 220 is connected to the MME/S-GW 230 which includes a processor 333 with an optional linked memory 334.

In LTE Rel-8, the OFDM symbols carrying the data channel (physical data shared channel (PDSCH)) follow immediately after the OFDM symbols carrying the control channel (physical dedicated control channel (PDCCH)). To extract the data, the WTRU needs to buffer the whole sub frame and decoding the control information which carries the resource allocation information for the WTRU. If there is no data transmitted to the WTRU, the whole subframe needs to be discarded, resulting in efficiency loss. In LTE-A, several carriers may be aggregated to increase the downlink transmission bandwidth up to 100 MHz. In this case, the loss would be increased significantly because the WTRU now needs to buffer a larger amount of data. This problem may be solved by introducing a timing offset between the control channel and the data channel such that the control channel carrying the resource allocation information for the corresponding data channel arrives in advance, (i.e., at least one LTE-A subframe earlier than the data channel).

LTE-A needs to be backward compatible with LTE. For the backward compatibility, the LTE-A control information must be located in the same OFDM symbols as LTE control channel so that the LTE WTRU may process the control information after receiving these OFDM symbols carrying the control channel. Otherwise, an LTE terminal, (i.e., a WTRU that supports only LTE), cannot decode the downlink control channel. If backward compatibility is not supported, the OFDM symbols supposed to be carrying the control channel may, for example, be carrying the data channel and an LTE WTRU would not be able to receive the control information.

However, subframe timing in LTE-A need not be aligned with the subframe timing in LTE. In accordance with one embodiment, the LTE-A subframe may be defined with boundaries different from the LTE subframe, but with control symbols in the same location in time in a way that the control information arrives one or several OFDM symbols before the corresponding data. In this way, a Rel8 LTE WTRU may co-exist with an LTE-A WTRU and the LTE-A WTRU may still get the benefit of advanced control information.

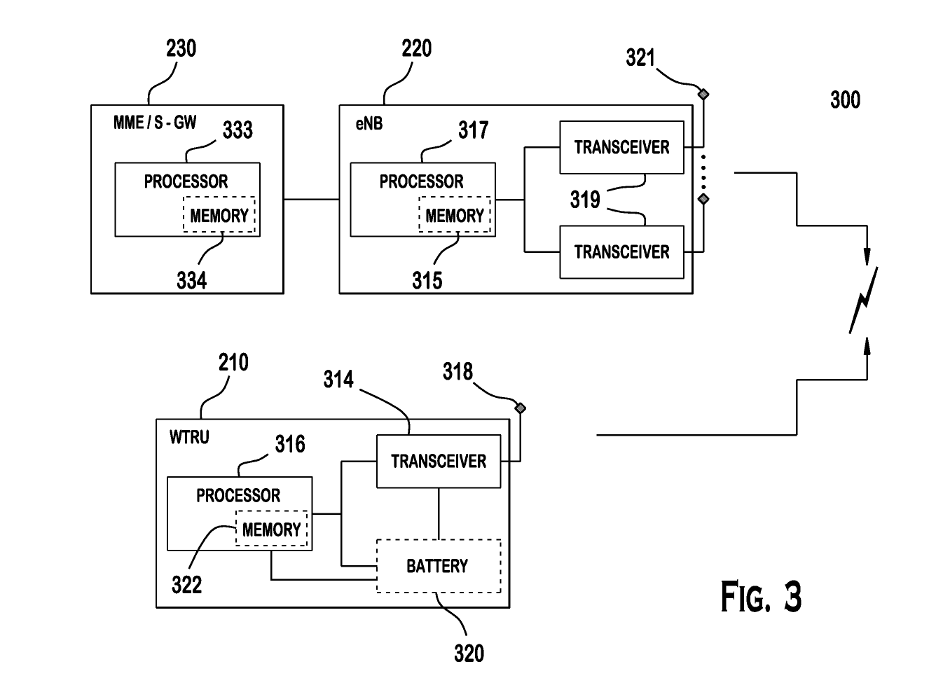

FIG. 4 shows an example transmission of downlink control information and data in accordance with one embodiment. In accordance with this embodiment, the LTE-A subframe is defined with boundaries different from the LTE subframe. In the example shown in FIG. 4, the control information (e.g., C1 symbols) is transmitted two (2) symbols prior to the corresponding data symbols (e.g., D1 symbols). It should be noted that two (2) symbols offset is an example and the control information may be transmitted one or more than two symbols before the corresponding data symbols. This scheme gives the WTRU time to determine which parts of the subcarriers need to be received without having to buffer any corresponding data symbols.

The offset value may be fixed by standards or be signaled on either a cell or WTRU basis. The offset information may be part of the broadcast message(s) or may be sent via layer 2 or 3 (L2/3) messaging on a per WTRU basis when the WTRU obtains radio resource control (RRC) connection in the cell or during RRC connection. Alternatively, the offset information may be part of the downlink control information so that the offset value may be varied dynamically (e.g., on a transmission time interval (TTI) basis on a per WTRU basis). If multiple carriers/bands are assigned for the WTRU (i.e., LTE-A WTRU), different offset values may be used for different carriers/bands.

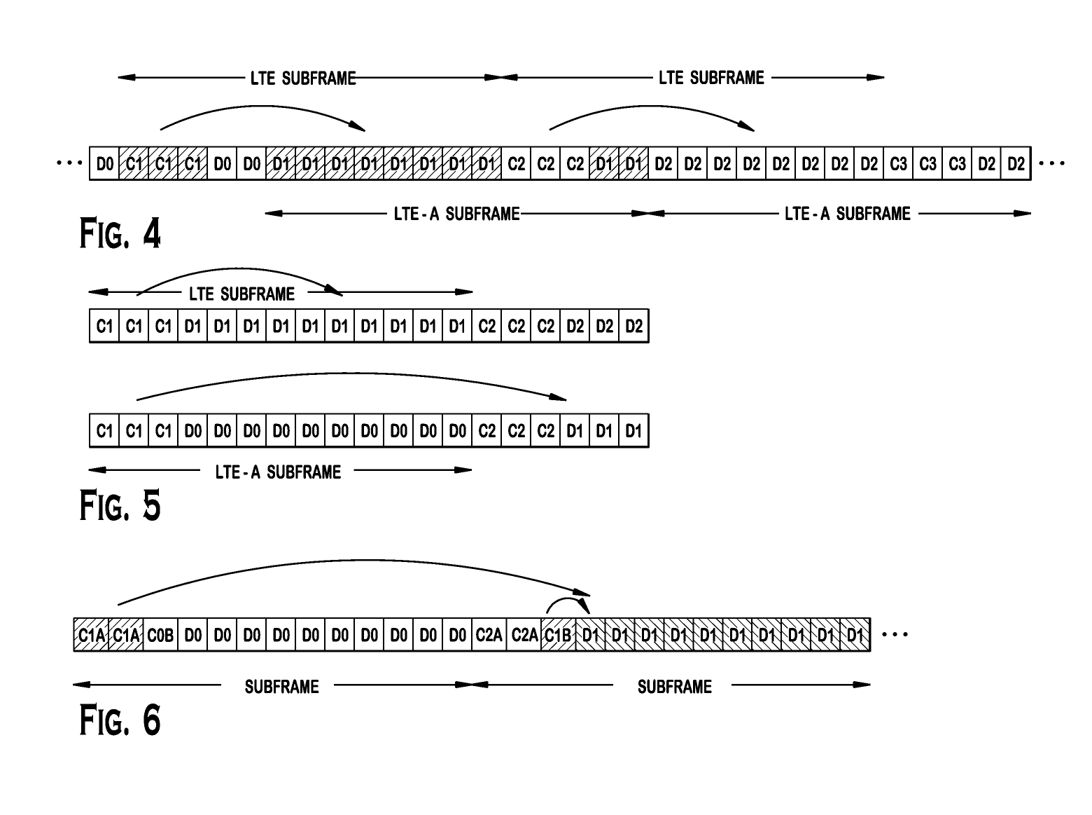

In accordance with another embodiment, in a given TTI, the control information, (i.e., the physical downlink control channel (PDCCH) field which includes the first N OFDM symbols of the subframe), contains the resource assignment information associated with the corresponding data (i.e., physical downlink shared channel (PDSCH)) or the control information in the next subframe or following subframes. FIG. 5 shows an example transmission of downlink control information and data in accordance with this embodiment. In FIG. 5, the control information (C1 symbols) is transmitted one (1) subframe prior to the corresponding data (D1 symbols). In this case, the LTE and LTE-A subframe timings are the same.

The PDCCH may include a data assignment indicator which indicates the WTRU where the corresponding data is located in terms of subframe number and/or component carrier/band if multiple carriers/bands are assigned for the WTRU. The data assignment indicator may be sent via L2/3 signaling on a per WTRU basis.

The PDCCH may include a control assignment indicator which indicates the WTRU where the control information is located in terms of subframe number and/or component carrier/band if multiple carriers/bands are assigned for the WTRU. The control assignment indicator may also be sent via L2/3 signaling on a per WTRU basis.

Alternatively, the control information (i.e., the PDCCH) may be split into k parts (for example, 2 parts). For data (i.e., the PDSCH) transmitted in the subframe n, the control information related to the frequency locations of the PDSCH is transmitted by the eNB in subframe (n-k) (for example, k may be 1), and other control information that is not related to the resource locations of the corresponding PDSCH is transmitted in the first M OFDM symbols in sub-frame n. FIG. 6 shows an example transmission of downlink control information and data in accordance with this alternative embodiment. In FIG. 6, the control information (CIA symbols) related to the frequency locations of the corresponding data is transmitted one (1) subframe prior to the corresponding data (D1 symbols), and other control information (C1B symbol) that is not related to the frequency locations of the corresponding data is transmitted in the same subframe that the corresponding data symbols are transmitted.

Although features and elements are described above in particular combinations, each feature or element can be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Application Specific Standard Products (ASSPs); Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, Mobility Management Entity (MME) or Evolved Packet Core (EPC), or any host computer. The WTRU may be used in conjunction with modules, implemented in hardware and/or software including a Software Defined Radio (SDR), and other components such as a camera, a video camera module, a videophone, a speakerphone, a vibration device, a speaker, a microphone, a television transceiver, a hands free headset, a keyboard, a Bluetooth® module, a frequency modulated (FM) radio unit, a Near Field Communication (NFC) Module, a liquid crystal display (LCD) display unit, an organic light-emitting diode (OLED) display unit, a digital music player, a media player, a video game player module, an Internet browser, and/or any Wireless Local Area Network (WLAN) or Ultra Wide Band (UWB) module.

What is claimed is:

1. A method implemented in a wireless transmit/receive unit (WTRU) for receiving orthogonal frequency division multiplex (OFDM)-based transmissions, the method comprising:
receiving control information;
decoding the control information; and
receiving data based on the decoded control information, wherein the control information and the data are separated by at least one OFDM symbol.

2. The method of claim 1 wherein the control information is received in first N OFDM symbols of a subframe.

3. The method of claim 2 wherein the control information includes an indicator indicating the WTRU where the data is located in terms of at least one of subframe number or component carrier.

4. The method of claim 1 wherein control information related to frequency location of the data is received in first N OFDM symbols of a subframe preceding a subframe including the data and control information not related to the frequency location of the data is received in the subframe including the data.

5. The method of claim 1 wherein the control information is included in a subframe preceding a subframe including the data.

6. The method of claim 1 wherein an offset between the control information and the data is a fixed value.

7. The method of claim 1 wherein the WTRU receives information indicating an offset between the control information and the data from a Node-B.

8. A wireless transmit/receive unit (WTRU) for receiving orthogonal frequency division multiplex (OFDM)-based transmissions, the WTRU comprising:
a transceiver configured to receive a subframe including a plurality of OFDM symbols for control information and data; and
a processor configured to decode the control information and control the transceiver to receive the data based on the decoded control information, wherein the control information and the data are separated by at least one OFDM symbol.

9. The WTRU of claim 8 wherein the control information is included in first N OFDM symbols of a subframe.

10. The WTRU of claim 9 wherein the control information includes an indicator indicating where the data is located in terms of at least one of subframe number or component carrier.

11. The WTRU of claim 8 wherein control information related to frequency location of the data is received in first N OFDM symbols of a subframe preceding a subframe including the data and control information not related to the frequency location of the data is received in a subframe including the data.

12. The WTRU of claim 8 wherein the control information is included in a subframe preceding a subframe including the data.

13. The WTRU of claim 8 wherein an offset between the control information and the data is a fixed value.

14. The WTRU of claim 8 wherein an offset between the control information and the data is determined based on information received from a Node-B.

15. An apparatus for sending orthogonal frequency division multiplex (OFDM)-based transmissions, the apparatus comprising:
a transceiver configured to send a subframe comprising a plurality of OFDM symbols; and
a processor configured to send control information and data, wherein a frequency location of OFDM symbols for the data destined to a wireless transmit/receive unit (WTRU) is indicated by the control information, and the control information and the data are separated by at least one OFDM symbol.
